(19) United States
(12) Patent Application Publication
(10) Pub. No.: US 2024/0161115 A1
(43) Pub. Date: May 16, 2024

(54) FRAUD DETECTION USING REAL-TIME AND BATCH FEATURES

(71) Applicant: Stripe, Inc., South San Francisco, CA (US)

(72) Inventors: Ryan Drapeau, Seattle, WA (US); Logan Howard, Seattle, WA (US); Seth Hendrickson, Reno, NV (US); Isaac Madwed, Seattle, WA (US)

(21) Appl. No.: 17/985,732

(22) Filed: Nov. 11, 2022

(51) Int. Cl. G06Q 20/40

(52) U.S. Cl. CPC G06Q 20/4016

(57) ABSTRACT

A method and system for detecting a fraudulent payment are described herein. The method can include detecting, at a server computer system, a request to perform a transaction between a merchant system and a customer of the merchant system, and in response to the detecting, determining, in real time one or more real time features corresponding to the transaction. The method may also include determining, by the server computer system, one or more batch features that correspond to one or more attributes associated with the transaction. The method may also include determining, by the server computer system, whether the payment is potentially fraudulent based on utilizing a model that includes inputs corresponding to the combination of the one or more real time features and the one or more batch features, and in response to determining that the payment is potentially fraudulent, performing, a remediation action associated with the transaction.

### FIELD

Embodiments of the present disclosure relate to the field of systems for software service; more particularly, embodiments of the present disclosure relate to fraud detection for software service.

### BACKGROUND

Software services play a critical role in modern society. Fraud in software services may cause severe economic loss, even disruption of business operations. A software service may include a payment transaction between a customer user device and a merchant system, which may be processed or otherwise facilitated by a server computer system. For the transaction, payment information is provided by the customer user device to the merchant system in satisfaction of the transaction. Such transactions, however, often occur between unknown parties, over a network between remote systems, etc. Thus, whether or not the payment information is fraudulent is of great importance to the merchant system, as well as the server computer system processing the transaction.

Conventionally, only real time features of a transaction are used to determine a fraudulent payment in an incoming transaction. Real time features are generated based on the incoming transaction. However, real time features cannot provide much information about the typical behavior of a user, because of the limited complexity of the real time features, due to the real time features being computed in real time. Thus, it is difficult to detect some fraudulent payments only using the real time features. It is challenging to detect the fraudulent payment effectively to provide a secure experience.

### SUMMARY

A method and system for a server computer system for detecting a fraudulent payment. In one embodiment, the method comprises detecting, at the server computer system, a request to perform a transaction between a merchant system and a customer of the merchant system. The method comprises that, in response to the detecting, determining, in real time, at the server computer system, one or more real time features corresponding to the transaction. The method comprises determining, by the server computer system, one or more batch features that correspond to one or more attributes associated with the transaction, where the one or more batch features are historical features that are pre-identified, prior to the transmission of the request for the transaction, using historical transaction data over a period of time. The method comprises determining, by the server computer system, whether the payment is potentially fraudulent based on utilizing a mod& that includes inputs corresponding to the combination of the one or more real time features and the one or more batch features. The method comprises that, in response to determining that the payment is potentially fraudulent, performing, by the server computer system, a remediation action associated with the transaction.

### BRIEF DESCRIPTION OF THE DRAWINGS

The present disclosure will be understood more fully from the detailed description given below and from the accompanying drawings of various embodiments of the disclosure, which, however, should not be taken to limit the disclosure to the specific embodiments, but are for explanation and understanding only.

FIG. 1 is a block diagram of an example of a system including a commerce platform to perform fraud detection while processing a transaction.

FIG. 2 is a block diagram of an example of a fraud detection system at a commerce platform.

FIG. 3 is a flow diagram of an example of a fraud detection system detecting a fraudulent payment at a commerce platform using a combination of real-time and batch features.

FIG. 4 is a flow diagram of one embodiment of a process of detecting a fraudulent payment using a combination of real-time and batch features.

FIG. 5 is a block diagram of one embodiment of a computer system that may be used to support the systems and operations discussed herein.

### DETAILED DESCRIPTION

Conventionally, fraud determinations are based on real time features, which are generated based on an incoming transaction in real time. The transaction may be a payment transaction between a customer user device and a merchant system, which is processed or otherwise facilitated by a server computer system. For the transaction, payment information is provided by the customer user device to the merchant system in satisfaction of the transaction. Such transactions, however, often occur between unknown parties, over a network between remote systems, etc. Thus, whether or not the payment information is fraudulent is of great importance to the merchant system, as well as the server computer system processing the transaction.

The real time features are based on current data, e.g., features that are updated in real time. For example, the real time features may be sessionized real time features, which are real time features of a current session. A session may be a period of time. As an example, a session may have a session length parameter of 1 hour, 24 hours, a week or any other values. However, the real time features are in reference to the current time and do not have historical values. Thus, the typical behavior of a user, e.g., on a card/email, cannot be obtained from the real time features. Detecting fraud in the incoming transactions effectively therefore represents a technical challenge to be addressed.

As will be discussed herein, to address the challenges in fraud detection and to further improve fraud detection, both historical features and real time features are used to determine a fraudulent payment in an incoming transaction. Techniques are described herein for detecting the fraudulent payment, using a combination of offline/batch computed features and real time features. The batch features are features computed offline based on historical data, not in real time based on recent data. The batch features are historical features that are pre-identified. The batch features also include features that correspond to disparate data sources that are too expensive to compute online. The batch features may represent the typical behavior of a user effectively. The batch features may be compared to the real time features to detect anomalies. For example, the batch features may efficiently represent the historical behavior of the user by using a mean value, and/or standard deviation of an attribute of a merchant per session of a transaction for a credit card. The batch features may be computed based on historical data for multiple sessions of the transaction, e.g., the latest 10 sessions of the transaction. Combined features based on both the batch features and the real time feature may be generated. For example, the combined features may represent the difference between the user's typical behavior and the behavior on the current session in real time. With a combination of the real time features, the batch features and the combined features, the fraudulent payment is detected effectively. Thus, the fraud detection is efficient, providing the secure experience to the merchants and the customers. Accordingly, the embodiments of the present disclosure reduce the amount of networking resources needed to detect the fraudulent payment, as well as, a decrease in network congestion and power consumption for the overall network infrastructure.

Certain terminology is used herein for convenience only and is not to be taken as a limitation on the present disclosure. Embodiments of the present disclosure are described in the context of an online payment acceptance service, such as Stripe®, but are not limited to online payment acceptance services. For example, the techniques discussed herein may be employed to any transaction system where fraudulent transactions are to be detected.

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “detecting”, “determining”, “performing”, “sending”, “generating”, “searching”, “selecting”, “receiving”, “matching”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

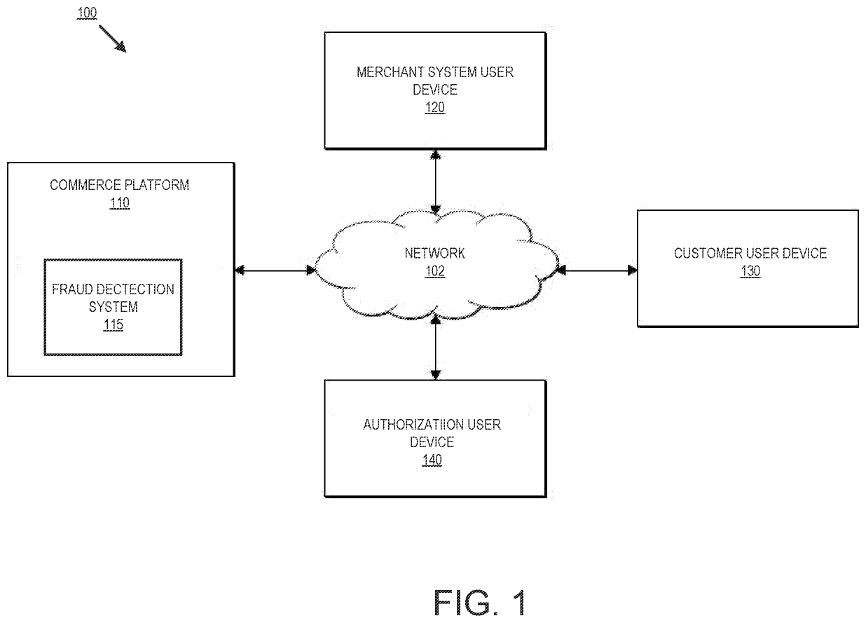

FIG. 1 is a block diagram of an example of a system including a commerce platform to perform fraud detection while processing a transaction. In one embodiment, the system 100 includes a commerce platform 110, a merchant system user device 120, a customer user device 130, and an authorization network user device 140. In one embodiment, user devices (e.g., devices 120, 130, and 140) may be mobile computing devices, such as a smartphone, tablet computer, smartwatch, etc., as well computer systems, such as a desktop computer system, laptop computer system, server computer systems, etc. The commerce platform 110 may also be one or more computing devices, such as one or more server computer systems, desktop computer systems, etc.

The commerce platform 110, merchant system user device 120, customer user device 130, and authorization network user device 140 may be coupled to a network 102 and communicate with one another using any of the standard protocols for the exchange of information, including secure communication protocols. In one embodiment, one or more of the commerce platform 110, merchant system user device 120, customer user device 130, and authorization network user device 140 may run on one Local Area Network (LAN) and may be incorporated into the same physical or logical system, or different physical or logical systems. Alternatively, the commerce platform 110, merchant system user device 120, customer user device 130, and authorization network user device 140 may reside on different LANs, wide area networks, cellular telephone networks, etc. that may be coupled together via the Internet but separated by firewalls, routers, and/or other network devices. In one embodiment, commerce platform 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, commerce platform 110 provides software service, e.g., financial processing services to one or more of merchant system user device 120, customer user device 130, and/or authorization network user device 140, such as managing accounts, running financial transactions, clearing transactions, performing payouts to agents, managing merchant and/or agent accounts, as well as other services typically associated with commerce platforms systems such as, for example, STRIPE™.

In one embodiment, commerce platform 110 includes a fraud detection system 115 to detect a fraudulent payment of a transaction. The fraud detection system 115 uses a combination of batch features and real time features to detect the fraudulent payment of the transaction to improve fraud detection over systems that rely on only real-time features. The details of the fraud detection system 115 will be discussed below.

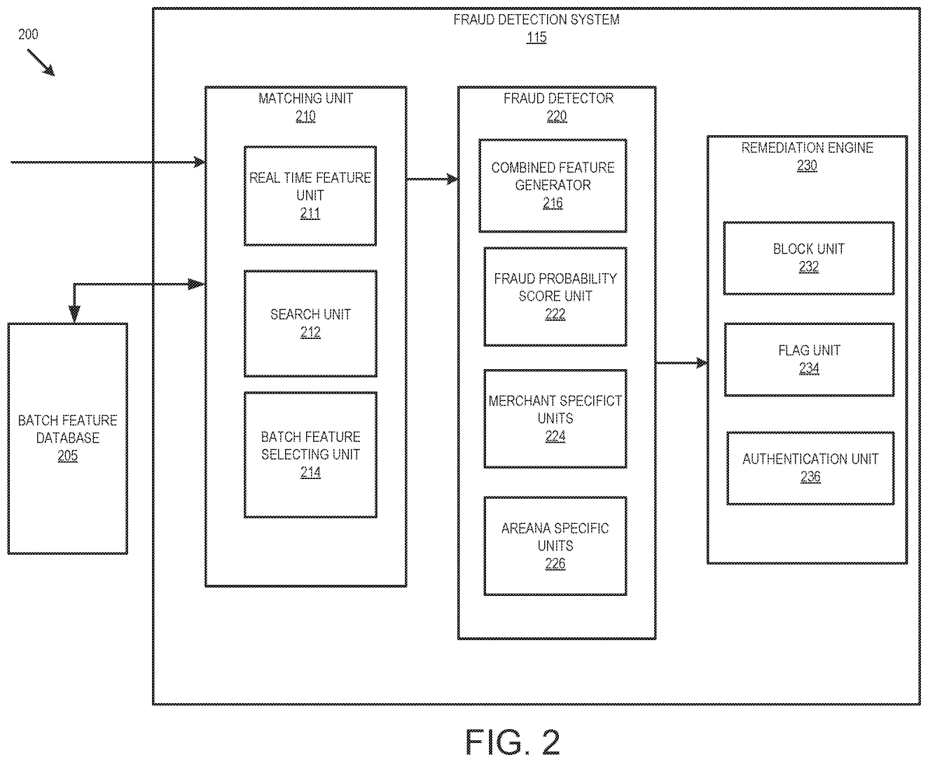

FIG. 2 is a block diagram 200 of an example of a fraud detection system 115 at a commerce platform. Referring to FIG.2, the fraud detection system 115 may include a matching unit 210, a detecting model 220 and a remediation model 230.

The matching unit 210 may include a real time feature unit 211, a search unit 212, and a batch feature selecting unit 214. The matching unit 210 is responsible for obtain one or more real time features and match one or more batch features to the one or more real time features. The real time feature unit 211 may be configured to detect a request to perform a transaction between a merchant system (e.g., 120) and a customer of the merchant system (e.g., 130) and determine the one or more real time features of the transaction.

The search unit 212 may search for one or more batch features in a batch features database 205, e.g., based on one or more search keys. The one or more batch features are historical features that are pre-identified using historical transaction data over a period of time. The one or more batch features also include features that correspond to disparate data sources that are expensive to compute online. The transaction may have one or more attributes. The one or more search keys may be associated with the one or more attributes of the transaction. For example, the transaction may have the following attributes: {Ch ID, “m”, “amount”, card No.}, where Ch ID represents a charge identifier (ID), “m” represents a merchant ID, “amount” represents a payment amount and card No. represents a number of a credit card. The one or more search keys may be determined based on the attribute “m” representing the merchant ID of the merchant, or the card.

The batch feature selecting unit 214 may select the one or more batch features that correspond to one or more attributes associated with the transaction. For example, the batch feature may be expressed {M, value A}, or {card. No. value B}, where M represents the merchant. The batch feature {M, value A} corresponding to the attribute “m” representing the merchant ID associated with the transaction may be selected. The one or more real time features and the one or more batch features are then provided from the matching unit 210 as inputs into the detecting module 220.

The fraud detector 220, upon receiving the inputs from the matching unit 210, determines whether the payment is potentially fraudulent based on the one or more real time features and the one or more batch features. The fraud detector 220 may include a combined feature generator 216 to generate one or more combined features based on the one or more real time features and the one or more batch features. The fraud detector 220 may include a fraud probability score unit to determine a fraud probability score of the transaction based on the one or more real time features, the one or more batch features and the one or more combined features. The fraud detector 220 may include merchant specific units 224 to generate merchant specific features. The fraud detector 220 may include arena specific units to generate arena specific features.

The remediation engine 230 may perform a remediation action associated with the transaction based on a fraud detection result of the fraud detector 220. The remediation model 230 may include block unit 232, a flag unit 234 and an authentication unit 236. The block unit 232 may block the payment or the transaction, based on the fraud probability score is higher than a first threshold. The flag unit 234 may label the payment or the transaction with a flag indicating potentially fraud for further review in response to the fraud probability score is higher than a second threshold and lower than the first threshold. Furthermore, the authentication unit 236 may request, from the customer, additional authentication for the payment or the transaction. The additional authentication information, in embodiments, may be used to supplement transaction data, and in embodiments is analyzed with the original transaction data by the fraud detection system 115.

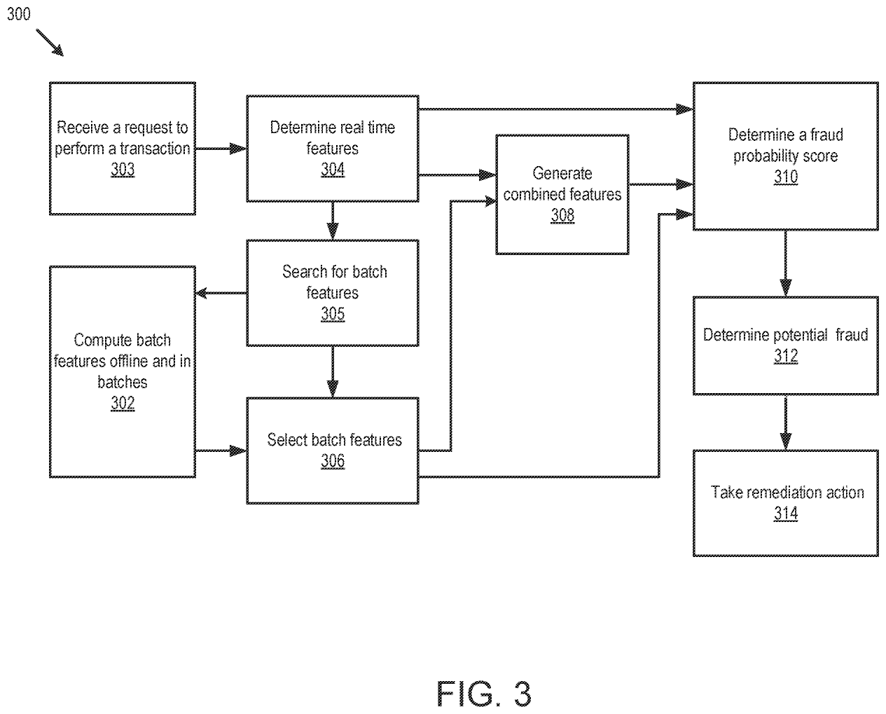

FIG. 3 is a flow diagram 300 of an example of a fraud detection system detecting a fraudulent payment at a commerce platform using a combination of real-time and batch features. The process 300 is performed by processing logic that may comprise hardware (circuitry, dedicated logic, etc.), software (such as is run on a general purpose computer system or a dedicated machine), firmware, or a combination. In one embodiment, the process 300 is performed by a fraud detection system (e.g., fraud detection system 115 of commerce platform 110).

In embodiments of the process 300, one or more batch features may be computed offline and in batches. The one or more batch features may include complex features, which may be impossible to compute in real time. For example, the real time features have to be quick to update and only include current data. The batch features may take longer to compute and are more complex to update. For example, the batch features may be computed based aggregation of a batch of historical data. The detecting model may take in both the real time features as well as the batch features. In addition, one or more combined features based on a combination of the real time features and the batch features may be constructed or generated. The detecting model may evaluate whether the payment is fraudulent based on the combination of the real time features and the batch features.

Referring to FIG. 3, at processing block 302, the one or more batch features may be computed offline and in batches. The one or more batch features are historical features that are pre-identified using historical transaction data over a period of time. The batch features include complex features, which may be impossible or too slow to compute in real time online. For example, the batch features may be computed based aggregation of a batch of historical data. The batch features may represent the typical behavior of a user effectively. For example, the batch features may efficiently represent the historical behavior of the user by using a mean value, and/or standard deviation of an attribute of a merchant per session of multiple sessions of a transaction, e.g., for a credit card. The batch features may be computed based on historical data for the latest 10 sessions of the transaction.

The batch features may include a variety of features, which may help to detect the fraudulent payment. For example, the batch features may include a typical payment velocity on a card, an average length of time between transactions for a card on a merchant, an amount of the transaction in a certain period of time, a number of emails seen for the card in a certain period of time, a number of shipping addresses associated with the transaction, a number of fraudulent payment disputes associated with the card, a number of cards for a shipping address, or the geolocation of the card holder, etc. The computed batch features may be saved in a batch feature database, such as the batch feature database 205 in FIG. 2.

The batch features may also include features that correspond to disparate data sources that are too expensive to compute online. For example, the batch features may also include merchant statistics, which may include statistic information for every merchant that updates every day from multiple data sources. The batch features may be used to join multiple data sources in a way which is too computationally intensive to do in a short period of time online. For example, the batch features may be computed based on different data tables from different data sources. The different data tables may include data about cardholders, data about merchants, data about transactions, etc. The different data tables from different data sources may be joined together to generate the batch features. For example, some merchants may have a list of trusted customers or have an allow list, the batch features may be generated based on the allow list to help to decide that certain transactions are not risky, e.g., for other merchants.

At processing block 303, a request to perform a transaction between a merchant system and a customer of the merchant system may be received. At processing block 304, one or more real time features corresponding to the transaction may be determined. The one or more real time features may be computed online based on current data of a current session.

At processing block 305, a list of batch features in the batch features database is searched based one or more search keys of the transaction. As discussed above, the transaction may have one or more attributes. The search keys are determined based on the one or more attributes associated with transaction. For example, the transaction may have the following attributes: {Ch ID, “m”, “amount”, card No.}, where Ch ID represents a charge identifier (ID), “m” represents a merchant ID, “amount” represents a payment amount and card No. represents a number of a credit card. The one or more search keys may be determined based on the attribute “m” representing the merchant ID of the merchant, or the card.

At processing block 306, one or more batch features that correspond to the one or more attributes associated with the transaction may be selected from the list of batch features in the batch features database. For example, a batch feature may be expressed as {M, x}, where M represents a merchant, and x represents a value of the batch feature. The transaction may have the follow attributes: {Ch ID, “m”, “amount”}, where Ch ID represents a charge identifier (ID), m represents a merchant, “amount” represents a payment amount. A search key may be determined based on the attribute “m” representing a merchant ID of the merchant. The batch feature {M, x} corresponding to the attribute “m” representing the merchant ID may be selected.

The batch features may be combined with the real time features to determine the probability of fraud or the likelihood that the transaction is going to be disputed for fraud. For instance, a batch feature may be the typical payment velocity on the card per session versus the current payment velocity in the current session. If the typical payment velocity on the card per week is one with some standard deviation, however, the payment velocity on the card in the current week is 10. The likelihood of a fraudulent payment is high, and the fraud probability score is determined to be high.

At block 308, one or more combined features based on both the batch features and the real time feature may be generated. The combined features may represent the difference between the user's typical behavior and the behavior on the current session in real time. For example, a combined feature, such as a Z score, may be generated based on one or more batch features, e.g., at least one of the mean value or the standard deviation of an attribute of a transaction, and a real time feature, e.g., a value of the attribute of the transaction. The mean value or the standard deviation of the attribute may be computed offline and saved in the batch features database. When a request for a transaction comes in online, the real time value of the attribute may be obtained, Then, the corresponding batch features may be selected. Afterwards, the combined features may be generated. The combined feature Z score may be expressed as:

Z score=(x−μ)/ [symbol] ,

where x represents the real time value of the attribute, p represents the mean value of the attribute, and [symbol] represents the standard deviation of the attribute.

At block 310, a fraud probability score may be determined. The fraud probability score may be determined based on the real time features, the batch features and the combined features using a machine learning model. The fraud probability score may indicate the likelihood that the payment is fraudulent. For example, the fraud probability score may be a function of one or more variables based on the real time features, the batch features and the combined features. In some examples, the fraud probability score may be generated by the machine learning model trained to detect the fraudulent payment based on the combination of the real time features and the batch features. Then the remediation may form feedback data for retraining the machine learning model to improve the accuracy of the fraud probability score and thus the underlying fraud detection and the combined features.

At block 312, a potential fraud is determined based on the fraud probability score. For example, determination that the payment within the transaction is potentially fraudulent is determined in response to the fraud probability score being higher than a predetermined threshold. Conversely, when the fraud probability score does not satisfy the predetermined threshold, the payment within the transaction is considered to be legitimate and not fraudulent.

At block 314, one or more remediation actions are taken in response to determining potential fraud within the transaction. For example, the one or more remediation actions may include blocking the transaction, flagging the transaction as potentially fraudulent, or requiring additional authentication action to be performed by one of the transaction parties.

In some examples, a merchant specific feature based on the combination of the one or more real time features and the one or more batch features may be generated. Extracted features regarding a merchant may be used to create the merchant specific feature, which may be input into the model and be used with respect to fraud determination. The model may include different merchant specific features for different merchants. The fraud determination may be made based on the merchant specific features.

In some examples, multiple separate models may be trained for multiple arenas, where each model may be trained for a specific arena. As an example, one model may be specifically trained for e-commerce. A feature based determination may be used to determine which model to utilize for the fraud determination and then provide the inputs to the appropriate model. For example, e-commerce related transactions may use the model that is specifically trained for e-commerce.

By using the combination of the real time features and the batch features, the fraudulent payment detection is more robust and more effective, and it is more difficult for a fraudulent payment to evade detection. Thus, the fraud detection is more efficient, providing more secure experience to the merchants and the customers. In this way, the amount of networking resources needed to detect the fraudulent payment is reduced. The network congestion and power consumption for the overall network infrastructure is decreased.

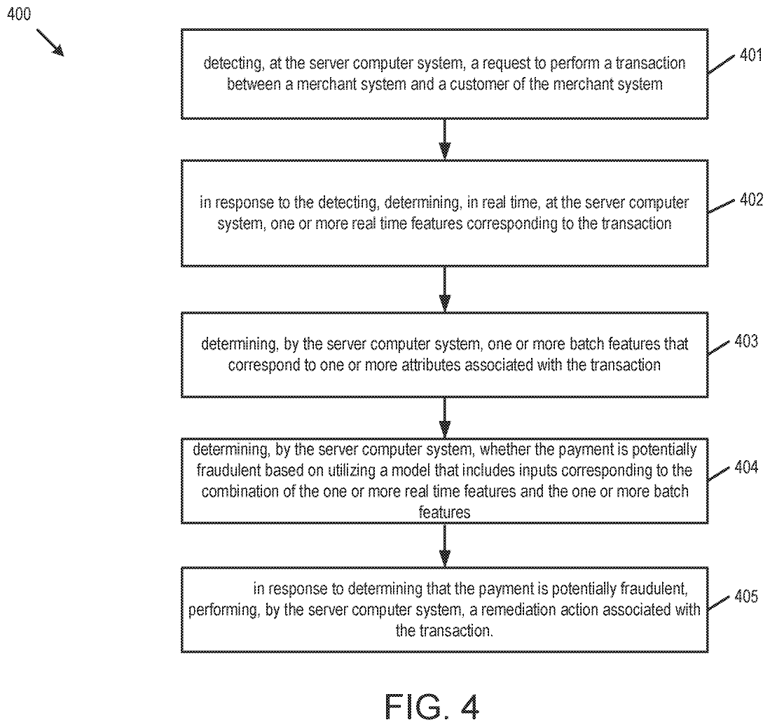

FIG. 4 is a flow diagram of one embodiment of a process 400 of detecting a fraudulent payment using a combination of real-time and batch features. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three. In one embodiment, the process 400 is performed by a fraud detection system (e.g., fraud detection system 115 of commerce platform 110).

Referring to FIG. 4, the process begins by detecting, at a server computer system, a request to perform a transaction between a merchant system and a customer of the merchant system (processing block 401). As discussed herein, the transaction may be a payment transaction between a customer user device and a merchant system, which is processed or otherwise facilitated by the server computer system. For the transaction, payment information is provided by the customer user device to the merchant system in satisfaction of the transaction. Furthermore, the server system may be a commerce platform, as discussed above. Such transactions, however, often occur between unknown parties, over a network between remote systems, etc. Thus, whether or not the payment information is fraudulent is of great importance to the merchant system, as well as the server computer system processing the transaction.

In response to the detecting, processing logic determines, in real time, at the server computer system, one or more real time features corresponding to the transaction (processing block 402).

Then, processing logic determines, by the server computer system, one or more batch features that correspond to one or more attributes associated with the transaction (processing block 403).

In one embodiment, processing logic may search a list of batch features computed previously based one or more search keys of the transaction, where the one or more search keys may be determined based on the one or more attributes associated with transaction. In one embodiment, processing logic may select the one or more batch features corresponding to the one or more attributes associated with the transaction from the list of batch features.

In one embodiment, the one or more batch features may represent a historical behavior of the customer, and where a batch feature of the one or more batch features may include at least one of a mean value or a standard deviation of an attribute per session of multiple sessions of the transaction.

Afterwards, processing logic determines, by the server computer system, whether the payment is potentially fraudulent based on utilizing a model that includes inputs corresponding to the combination of the one or more real time features and the one or more batch features (processing block 404).

In one embodiment, the model may use a combination of the one or more real time features, the one or more batch features, and one or more combined features that correspond to the combination of the real time features and the batch features.

In one embodiment, processing logic may generate one or more combined features that correspond to the combination of the one or more real time features and the one or more batch features. In one embodiment, the combined features may represent a difference between the historical behavior of the customer and the behavior of the customer in real time, and where whether the payment is potentially fraudulent may be determined based on the one or more combined features.

In one embodiment, processing logic may determine a fraud probability score based on the combination of the one or more real time features and the one or more batch feature, where whether the payment is potentially fraudulent is determined based on the fraud probability score.

In one embodiment, the one or more real time features are associated with the merchant system. Processing logic may further generate a merchant specific feature based on the combination of the one or more real time features and the one or more batch features, where whether the payment is potentially fraudulent is determined based on the merchant specific feature.

In response to determining that the payment is potentially fraudulent, processing logic performs, by the server computer system, a remediation action associated with the transaction (processing block 405).

In one embodiment, the remediation action may include blocking the transaction, flagging the transaction as potentially fraudulent, or requiring additional authentication action to be performed by one of the transaction parties.

In one embodiment, the server computer system may comprise a commerce platform system, and where the merchant system utilizes the commerce platform system to process the transaction on behalf of the merchant system.

By this method, the fraudulent payment detection is robust and effective, and it is difficult for a fraudulent payment to evade the detection. Thus, the method provides the secure experience to the merchants and the customers. In this way, the amount of networking resources needed to detect the fraudulent payment is reduced. The network congestion and power consumption for the overall network infrastructure is decreased.

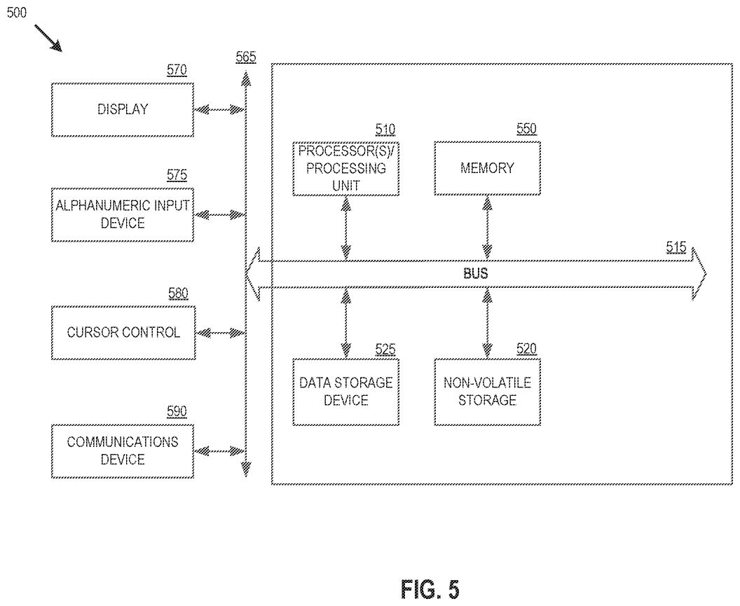

FIG. 5 is one embodiment of a computer system 500 that may be used to support the systems and operations discussed herein. It will be apparent to those of ordinary skill in the art, however, that other alternative systems of various system architectures may also be used.

The data processing system illustrated in FIG. 5 includes a bus or other internal communication means 515 for communicating information, and a processor(s) 510 coupled to the bus 515 for processing information. The system further comprises a random-access memory (RAM) or other volatile storage device 550 (referred to as memory), coupled to bus 515 for storing information and instructions to be executed by processor 510. Main memory 550 also may be used for storing temporary variables or other intermediate information during execution of instructions by processor(s) 510. The system also comprises a read only memory (ROM) and/or static storage device 520 coupled to bus 515 for storing static information and instructions for processor 510, and a data storage device 525 such as a magnetic disk or optical disk and its corresponding disk drive. Data storage device 525 is coupled to bus 515 for storing information and instructions.

The system may further be coupled to a display device 570, such as a light emitting diode (LED) display or a liquid crystal display (LCD) coupled to bus 515 through bus 565 for displaying information to a computer user. An alphanumeric input device 575, including alphanumeric and other keys, may also be coupled to bus 515 through bus 565 for communicating information and command selections to processor 510. An additional user input device is cursor control device 580, such as a touchpad, mouse, a trackball, stylus, or cursor direction keys coupled to bus 515 through bus 565 for communicating direction information and command selections to processor 510, and for controlling cursor movement on display device 570.

Another device, which may optionally be coupled to computer system 500, is a communication device 590 for accessing other nodes of a distributed system via a network. The communication device 590 may include any of a number of commercially available networking peripheral devices such as those used for coupling to an Ethernet, token ring, Internet, or wide area network. The communication device 590 may further be a null-modem connection, or any other mechanism that provides connectivity between the computer system 500 and the outside world. Note that any or all of the components of this system illustrated in FIG. 5 and associated hardware may be used in various embodiments as discussed herein.

In one embodiment, processor(s) 510 executes instructions to perform any of the operations described above including, but not limited to, detecting, at the server computer system 500, a request to perform a transaction between a merchant system and a customer of the merchant system; in response to the detecting, determining, in real time, at the server computer system, one or more real time features corresponding to the transaction; determining, by the server computer system, one or more batch features that correspond to one or more attributes associated with the transaction, wherein the one or more batch features are historical features that are pre-identified, prior to the transmission of the request for the transaction, using historical transaction data over a period of time; determining, by the server computer system, whether the payment is potentially fraudulent based on utilizing a model that includes inputs corresponding to the combination of the one or more real time features and the one or more batch features; and in response to determining that the payment is potentially fraudulent, performing, by the server computer system, a remediation action associated with the transaction.

It will be appreciated by those of ordinary skill in the art that any configuration of the system may be used for various purposes according to the particular implementation. The control logic or software implementing the described embodiments can be stored in main memory 550, mass storage device 525, or other storage medium locally or remotely accessible to processor 510.

It will be apparent to those of ordinary skill in the art that the system, method, and process described herein can be implemented as software stored in main memory 550 or read only memory 520 and executed by processor 510. This control logic or software may also be resident on an article of manufacture comprising a computer readable medium having computer readable program code embodied therein and being readable by the mass storage device 525 and for causing the processor 510 to operate in accordance with the methods and teachings herein.

The embodiments discussed herein may also be embodied in a handheld or portable device containing a subset of the computer hardware components described above. For example, the handheld device may be configured to contain only the bus 565, the processor 510, and memory 550 and/or 525. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 510, a data storage device 525, a bus 515, and memory 550, and only rudimentary communications mechanisms, such as a small touch-screen that permits the user to communicate in a basic manner with the device. In general, the more special-purpose the device is, the fewer of the elements need to be present for the device to function.

There are a number of example embodiments described herein.

Example 1 is a method for a server computer system detecting a fraudulent payment, comprising: detecting, at the server computer system, a request to perform a transaction between a merchant system and a customer of the merchant system; in response to the detecting, determining, in real time, at the server computer system, one or more real time features corresponding to the transaction; determining, by the server computer system, one or more batch features that correspond to one or more attributes associated with the transaction, wherein the one or more batch features are historical features that are pre-identified, prior to the transmission of the request for the transaction, using historical transaction data over a period of time; determining, by the server computer system, whether the payment is potentially fraudulent based on utilizing a model that includes inputs corresponding to the combination of the one or more real time features and the one or more batch features; and in response to determining that the payment is potentially fraudulent, performing, by the server computer system, a remediation action associated with the transaction.

Example 2 is the method of example 1 that may optionally include that the model uses a combination of the one or more real time features, the one or more batch features, and one or more combined features that correspond to the combination of the real time features and the batch features.

Example 3 is the method of example 1 that may optionally include that the determining, by the server computer system, the one or more batch features that correspond to the one or more attributes associated with the transaction comprises: searching a list of batch features computed previously based one or more search keys of the transaction, wherein the one or more search keys are determined based on the one or more attributes associated with transaction; and selecting the one or more batch features corresponding to the one or more attributes associated with the transaction from the list of batch features.

Example 4 is the method of example 1 that may optionally include that the one or more batch features represent a historical behavior of the customer, and where a batch feature of the one or more batch features includes at least one of a mean value or a standard deviation of an attribute per session of multiple sessions of the transaction.

Example 5 is the method of example 1 that may optionally include that generating one or more combined features that correspond to the combination of the one or more real time features and the one or more batch features.

Example 6 is the method of example 5 that may optionally include that the combined features represent a difference between the historical behavior of the customer and the behavior of the customer in real time, and where whether the payment is potentially fraudulent is determined based on the one or more combined features.

Example 7 is the method of example 1 that may optionally include that determining a fraud probability score based on the combination of the one or more real time features and the one or more batch feature, wherein whether the payment is potentially fraudulent is determined based on the fraud probability score.

Example 8 is the method of example 1 that may optionally include that, where the one or more real time features are associated with the merchant system, the method further comprising: generating a merchant specific feature based on the combination of the one or more real time features and the one or more batch features, wherein whether the payment is potentially fraudulent is determined based on the merchant specific feature.

Example 9 is the method of example 1 that may optionally include that the remediation action includes blocking the transaction, flagging the transaction as potentially fraudulent, or requiring additional authentication action to be performed by one of the transaction parties.

Example 10 is the method of example 1 that may optionally include that the server computer system comprises a commerce platform system, and wherein the merchant system utilizes the commerce platform system to process the transaction on behalf of the merchant system.

Example 11 is one or more non-transitory computer readable storage media having instructions stored thereupon which, when executed by a system having at least a processor and a memory therein, cause the system to perform operations comprising: detecting, at the server computer system, a request to perform a transaction between a merchant system and a customer of the merchant system; in response to the detecting, determining, in real time, at the server computer system, one or more real time features corresponding to the transaction; determining, by the server computer system, one or more batch features that correspond to one or more attributes associated with the transaction, wherein the one or more batch features are historical features that are pre-identified, prior to the transmission of the request for the transaction, using historical transaction data over a period of time; determining, by the server computer system, whether the payment is potentially fraudulent based on utilizing a model that includes inputs corresponding to the combination of the one or more real time features and the one or more batch features; and in response to determining that the payment is potentially fraudulent, performing, by the server computer system, a remediation action associated with the transaction.

Example 12 is the computer readable storage media of example 11 that may optionally include that, where the determining, by the server computer system, the one or more batch features that correspond to the one or more attributes associated with the transaction comprises: searching a list of batch features computed previously based one or more search keys of the transaction, wherein the one or more search keys are determined based on the one or more attributes associated with transaction; and selecting the one or more batch features corresponding to the one or more attributes associated with the transaction from the list of batch features.

Example 13 is the computer readable storage media of example 11 that may optionally include that, the operations further comprise, generating one or more combined features that correspond to the combination of the one or more real time features and the one or more batch features.

Example 14 is the computer readable storage media of example 11 that may optionally include that, the operations further comprise, determining a fraud probability score based on the combination of the one or more real time features and the one or more batch feature, wherein whether the payment is potentially fraudulent is determined based on the fraud probability score.

Example 15 is the computer readable storage media of example 11 that may optionally include that where the one or more real time features are associated with the merchant system, where the operations further comprise: generating a merchant specific feature based on the combination of the one or more real time features and the one or more batch features, wherein whether the payment is potentially fraudulent is determined based on the merchant specific feature.

Example 16 is the computer readable storage media of example 11 that may optionally include that, where the remediation action includes blocking the transaction, flagging the transaction as potentially fraudulent, or requiring additional authentication action to be performed by one of the transaction parties.

Example 17 is a system comprising: a memory to store instructions; and one or more processors coupled to the memory to execute the stored instructions to: detect, at a server computer system, a request to perform a transaction between a merchant system and a customer of the merchant system; in response to the detecting, determine, in real time, at the server computer system, one or more real time features corresponding to the transaction; determine, by the server computer system, one or more batch features that correspond to one or more attributes associated with the transaction, wherein the one or more batch features are historical features that are pre-identified, prior to the transmission of the request for the transaction, using historical transaction data over a period of time; determine, by the server computer system, whether the payment is potentially fraudulent based on utilizing a model that includes inputs corresponding to the combination of the one or more real time features and the one or more batch features; and
in response to determining that the payment is potentially fraudulent, perform, by the server computer system, a remediation action associated with the transaction.

Example 18 is the system of example 17 that may optionally include that the one or more processors are further to: search a list of batch features computed previously based one or more search keys of the transaction, wherein the one or more search keys are determined based on the one or more attributes associated with transaction; and select the one or more batch features corresponding to the one or more attributes associated with the transaction from the list of batch features.

Example 19 is the system of example 18 that may optionally include that the one or more processors are further to: generate one or more combined features that correspond to the combination of the one or more real time features and the one or more batch features.

Example 20 is the system of example 19 that may optionally include that the one or more processors are further to: generate a merchant specific feature based on the combination of the one or more real time features and the one or more batch features, wherein whether the payment is potentially fraudulent is determined based on the merchant specific feature.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

We claim:

1. A method for a server computer system detecting a fraudulent payment, comprising:
detecting, at the server computer system, a request to perform a transaction between a merchant system and a customer of the merchant system;
in response to the detecting, determining, in real time, at the server computer system, one or more real time features corresponding to the transaction;
determining, by the server computer system, one or more batch features that correspond to one or more attributes associated with the transaction, wherein the one or more batch features are historical features that are pre-identified, prior to the transmission of the request for the transaction, using historical transaction data over a period of time;
determining, by the server computer system, whether the payment is potentially fraudulent based on utilizing a model that includes inputs corresponding to the combination of the one or more real time features and the one or more batch features; and
in response to determining that the payment is potentially fraudulent, performing, by the server computer system, a remediation action associated with the transaction.

2. The method of claim 1, wherein the model uses a combination of the one or more real time features, the one or more batch features, and one or more combined features that correspond to the combination of the real time features and the batch features.

3. The method of claim 1, wherein the determining, by the server computer system, the one or more batch features that correspond to the one or more attributes associated with the transaction comprises:
searching a list of batch features computed previously based one or more search keys of the transaction, wherein the one or more search keys are determined based on the one or more attributes associated with transaction; and
selecting the one or more batch features corresponding to the one or more attributes associated with the transaction from the list of batch features.

4. The method of claim 1, wherein the one or more batch features represent a historical behavior of the customer, and wherein a batch feature of the one or more batch features includes at least one of a mean value or a standard deviation of an attribute per session of multiple sessions of the transaction.

5. The method of claim 1, further comprising:
generating one or more combined features that correspond to the combination of the one or more real time features and the one or more batch features.

6. The method of claim 5, wherein the combined features represent a difference between the historical behavior of the customer and the behavior of the customer in real time, and wherein whether the payment is potentially fraudulent is determined based on the one or more combined features.

7. The method of claim 1, further comprising:
determining a fraud probability score based on the combination of the one or more real time features and the one or more batch feature, wherein whether the payment is potentially fraudulent is determined based on the fraud probability score.

8. The method of claim 1, wherein the one or more real time features are associated with the merchant system, the method further comprising:
generating a merchant specific feature based on the combination of the one or more real time features and the one or more batch features, wherein whether the payment is potentially fraudulent is determined based on the merchant specific feature.

9. The method of claim 1, wherein the remediation action includes blocking the transaction, flagging the transaction as potentially fraudulent, or requiring additional authentication action to be performed by one of the transaction parties.

10. The method of claim 1, wherein the server computer system comprises a commerce platform system, and wherein the merchant system utilizes the commerce platform system to process the transaction on behalf of the merchant system.

11. One or more non-transitory computer readable storage media having instructions stored thereupon which, when executed by a system having at least a processor and a memory therein, cause the system to perform operations comprising:
detecting, at a server computer system, a request to perform a transaction between a merchant system and a customer of the merchant system;
in response to the detecting, determining, in real time, at the server computer system, one or more real time features corresponding to the transaction;
determining, by the server computer system, one or more batch features that correspond to one or more attributes associated with the transaction, wherein the one or more batch features are historical features that are pre-identified, prior to the transmission of the request for the transaction, using historical transaction data over a period of time;
determining, by the server computer system, whether the payment is potentially fraudulent based on utilizing a model that includes inputs corresponding to the combination of the one or more real time features and the one or more batch features; and
in response to determining that the payment is potentially fraudulent, performing, by the server computer system, a remediation action associated with the transaction.

12. The one or more non-transitory computer readable storage media of claim wherein the determining, by the server computer system, the one or more batch features that correspond to the one or more attributes associated with the transaction comprises:
searching a list of batch features computed previously based one or more search keys of the transaction, wherein the one or more search keys are determined based on the one or more attributes associated with transaction; and
selecting the one or more batch features corresponding to the one or more attributes associated with the transaction from the list of batch features.

13. The one or more non-transitory computer readable storage media of claim 11, wherein the operations further comprise:
generating one or more combined features that correspond to the combination of the one or more real time features and the one or more batch features.

14. The one or more non-transitory computer readable storage media of claim 11, wherein the operations further comprise:
determining a fraud probability score based on the combination of the one or more real time features and the one or more batch feature, wherein whether the payment is potentially fraudulent is determined based on the fraud probability score.

15. The one or more non-transitory computer readable storage media of claim 11, wherein the one or more real time features are associated with the merchant system, wherein the operations further comprise:
generating a merchant specific feature based on the combination of the one or more real time features and the one or more batch features, wherein whether the payment is potentially fraudulent is determined based on the merchant specific feature.

16. The one or more non-transitory computer readable storage media of claim 11, wherein the remediation action includes blocking the transaction, flagging the transaction as potentially fraudulent, or requiring additional authentication action to be performed by one of the transaction parties.

17. A system comprising:
a memory to store instructions; and
one or more processors coupled to the memory to execute the stored instructions to:
detect, at a server computer system, a request to perform a transaction between a merchant system and a customer of the merchant system;
in response to the detecting, determine, in real time, at the server computer system, one or more real time features corresponding to the transaction;
determine, by the server computer system, one or more batch features that correspond to one or more attributes associated with the transaction, wherein the one or more batch features are historical features that are pre-identified, prior to the transmission of the request for the transaction, using historical transaction data over a period of time;
determine, by the server computer system, whether the payment is potentially fraudulent based on utilizing a model that includes inputs corresponding to the combination of the one or more real time features and the one or more batch features; and
in response to determining that the payment is potentially fraudulent, perform, by the server computer system, a remediation action associated with the transaction.

18. The system of claim 17, wherein the one or more processors are further to:
search a list of batch features computed previously based one or more search keys of the transaction, wherein the one or more search keys are determined based on the one or more attributes associated with transaction; and
select the one or more batch features corresponding to the one or more attributes associated with the transaction from the list of batch features.

19. The system of claim 17, wherein the one or more processors are further to:
generate one or more combined features that correspond to the combination of the one or more real time features and the one or more batch features.

20. The system of claim 17, wherein the one or more processors are further to:
generate a merchant specific feature based on the combination of the one or more real time features and the one or more batch features, wherein whether the payment is potentially fraudulent is determined based on the merchant specific feature.
